(19) United States
(12) Patent Application Publication
(10) Pub. No.: US 2015/0134231 A1
(43) Pub. Date: May 14, 2015

(54) SYSTEM AND METHOD FOR VEHICLE START-STOP

(71) Applicant: Yazaki North America, Inc., Canton, MI (US)

(72) Inventors: Kang Li, Canton, MI (US); Yongmin Sheng, Novi, MI (US)

(73) Assignee: YAZAKI NORTH AMERICA, INC., Canton, MI (US)

(21) Appl. No.: 14/075,545

(22) Filed: Nov. 8, 2013

(51) Int. Cl. F02D 17/04

(52) U.S. Cl. CPC F02D 17/04
USPC 701/112

(57) ABSTRACT

A start-stop module for a vehicle can include a capacitor, one or more switches and a controller. The switches can be configured to connect the capacitor in parallel or in series with a battery of the vehicle. The controller can receive an input voltage having a magnitude based on a connection between the capacitor and the battery, and output a desired voltage that is appropriate for operating accessory loads of the vehicle. The controller can control the switches to switch between a standby mode and a cranking mode. The capacitor is in parallel with the battery in standby mode and in series with the battery in cranking mode. The controller can switch to the cranking mode when the engine is about to be restarted and return to standby mode after the engine has been restarted and when the battery voltage reaches the desired voltage for the accessory loads.

### FIELD

The present disclosure relates to vehicles and, more particularly, to a system and method for vehicle start-stop.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A vehicle can have a start-stop system that selectively stops an internal combustion engine during periods of inactivity to decrease fuel consumption. For example, the start-stop system can stop the engine when the vehicle is stopped at a stop light. The start-stop system can then restart the engine when appropriate, e.g., in response to an action by a driver of the vehicle. For example, the start-stop system may restart the engine when the driver releases a brake pedal of the vehicle. During these periods of inactivity, accessory loads (air conditioning, headlights, radio/infotainment systems, etc.) require current to continue operation. For the start-stop system to restart the engine, however, the start-stop system may require a large amount of current to crank and restart the engine. This may decrease the current provided to the accessory loads, which can alter or suspend operation of the accessory loads.

### SUMMARY

In various embodiments of the present disclosure, a start-stop module for a vehicle is disclosed. The start-stop module can include a capacitor, one or more switches and a controller. The one or more switches can be configured to connect the capacitor (i) in parallel with a battery of the vehicle, or (ii) in series with the battery. The controller can be configured to receive an input voltage having a magnitude based on a connection between the capacitor and the battery, and output a desired voltage that is appropriate for operating one or more accessory loads of the vehicle. Further, the controller can be configured to control the one or more switches to switch between a standby mode and a cranking mode. The controller can control the one or more switches to connect the capacitor in parallel with the battery during standby mode. Also, the controller can control the one or more switches to connect the capacitor in series with the battery during cranking mode. The controller can switch to the cranking mode when the engine is not running and is about to be restarted during start-stop operation. Further, the controller can switch to the standby mode from the cranking mode after the engine has been restarted and when the battery has a battery voltage that reaches the desired voltage for the one or more accessory loads.

In various embodiments of the present disclosure, a start-stop system for a vehicle is disclosed. The start-stop system can include a first voltage source, an alternator, a second voltage source, one or more switches and one or more controllers. The one or more switches can configured to connect the second voltage source (i) in parallel with the first voltage source or (ii) in series with the first voltage source. The one or more controllers can be configured to temporarily stop an engine of the vehicle based on at least one of a driver input and a speed of the vehicle, determine whether to restart the engine based on at least one of the driver input and the speed of the vehicle, restart the engine in response to determining to restart the engine, receive an input voltage having a magnitude based on a connection between the first and second voltage sources, and output a desired voltage that is appropriate for operating one or more accessory loads of the vehicle. Further, the one or more controllers can be further configured to control the one or more switches to switch between a standby mode and a cranking mode. The second voltage source can be connected in parallel with the first voltage source during standby mode. The second voltage source can be connected in series with the first voltage source in during cranking mode. The controller can switch to the cranking mode when the engine is not running and is about to be restarted during start-stop operation. Further, the controller can switch to the standby mode from the cranking mode after the engine has been restarted and when the first voltage source has a voltage that reaches the desired voltage for the one or more accessory loads.

In various embodiments of the present disclosure, a method of start-stop operation of a vehicle is disclosed. The method can include controlling one or more switches to connect a first voltage source in parallel with a second voltage source of the vehicle during a standby mode. The method can further include providing a desired voltage from a controller to one or more accessory components of the vehicle, the desired voltage being appropriate for operating the one or more accessory components of the vehicle. Additionally, the method can include stopping the engine of the vehicle and determining whether to restart the engine of the vehicle. The method can also include switching to a cranking mode in response to determining to restart the engine and controlling the one or more switches to connect the first voltage source in series with the second voltage source during the cranking mode such that the controller receives an input voltage equal to a voltage of the first voltage source plus a voltage of the second voltage source. Further, the method can include stepping-down the input voltage to the desired voltage for the one or more accessory components of the vehicle during the cranking mode, as well as restarting the engine in response to determining to restart the engine. The method can also include monitoring the voltage of the second voltage source after restarting the engine and switching to the standby mode from the cranking mode when the voltage of the second voltage source reaches the desired voltage for the one or more accessory components of the vehicle.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example functional block diagram of a vehicle including a start-stop system according to some implementations of the present disclosure;

FIG. 2 is an example functional block diagram of the start-stop system of FIG. 1 including a start-stop module according to some implementations of the present disclosure;

FIG. 3A is an example functional block diagram of the start-stop module of FIG. 2;

FIG. 3B is an example circuit diagram of the start-stop module of FIG. 2;

FIG. 4 is an example functional block diagram of the controller and the start-stop system including the start-stop module according to some implementations of the present disclosure; and

FIG. 5 is an example flow diagram of a method of start-stop operation for a vehicle according to some implementations of the present disclosure.

### DETAILED DESCRIPTION

As previously discussed, for a start-stop system of a vehicle to restart an engine, the start-stop system may require a large amount of current to crank and restart the engine. This can decrease the current provided to one or more engine accessory loads (air conditioning, headlights, radio/infotainment systems, etc.), which can alter or suspend operation of the engine accessory loads. Vehicle start-stop systems having multiple batteries, a capacitor, or a direct current (DC) to DC converter can address this problem, but also increase costs, weight, complexity, and/or reliability of the vehicle start-stop systems. It should be appreciated that the description herein will ignore any parasitic voltage drop across connections, switches, and any other devices for the sake of simplicity.

Accordingly, a system and method of vehicle start-stop are presented. The system can be a start-stop module or a start-stop system that provides for decreased cost and/or weight compared to other start-stop implementations. The start-stop system can include an alternator, a first voltage source, e.g., a battery, and a start-stop module. The start-stop module can include a second voltage source, e.g., a capacitor, one or more switches, and a controller. The controller can control the one or more switches to connect the second voltage source in either parallel with the first voltage source (and under certain conditions, the alternator) in a “standby mode” or in series with the first voltage source in a “cranking mode” depending on start-stop operation of the engine.

Specifically, in the cranking mode the components can be connected in series when the engine is restarting (cranking) using the first voltage source in order to ensure adequate voltage for one or more accessory components. The controller can also step-down the combined voltage to the desired voltage for the accessory component(s). A method of start-stop operation of a vehicle can include stopping the engine and restarting the engine based on driver input and/or vehicle speed and concurrently operating the start-stop system/module in accordance with the above parallel/series connection switching and stepping-down of the combined voltage.

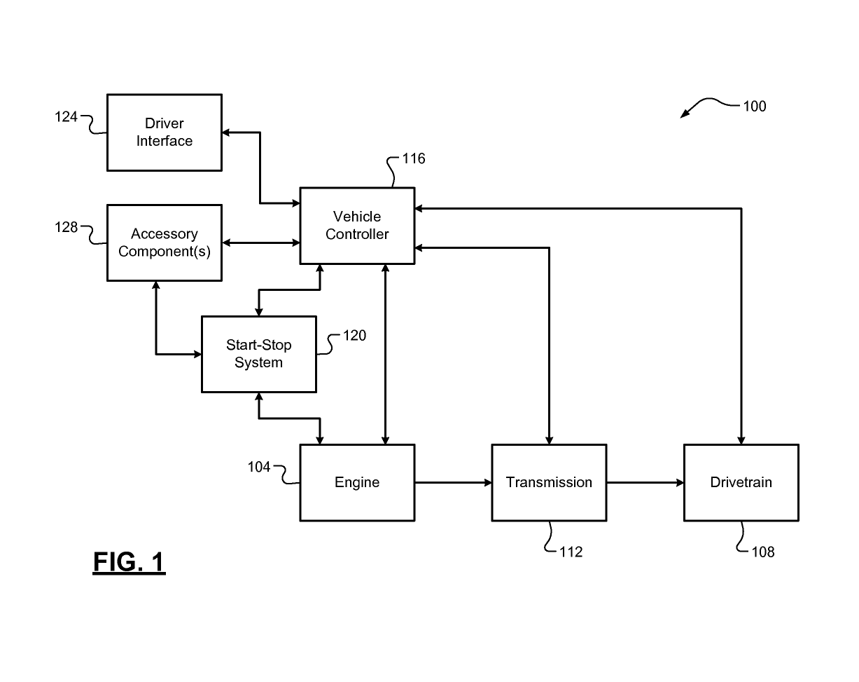

Referring now to FIG. 1, an example functional block diagram of a vehicle 100 is illustrated. The vehicle 100 can be propelled by an internal combustion engine 104 (hereinafter “engine 104”). The engine 104 can be any suitable type of engine (spark ignition, diesel, homogeneous charge compression ignition, etc.). The engine 104 can combust an air/fuel mixture within cylinders to drive pistons that rotatably turn a crankshaft to generate drive torque. The drive torque can be transferred to a drivetrain 108 via a transmission 112. The drivetrain 108 can include any suitable drivetrain components (differentials, a power transfer unit, etc.) that transfer the drive torque from the transmission 112 to one or more wheels of the vehicle 100. It should be appreciated that the vehicle 100 is merely an example, and the present disclosure is equally applicable to any type of vehicle, for example, an electric or hybrid vehicle that is propelled by an electric motor that receives power from a battery pack that can be recharged by operating the engine 104.

A vehicle controller 116 can control operation of the vehicle 100. Specifically, the vehicle controller 116 can control the engine 104 such that the engine 104 generates a desired drive torque. The desired drive torque can be based on a driver input from a driver interface 124. The driver interface 124 can include any suitable components for communication between a driver of the vehicle 100 and the vehicle controller 116. For example, the driver interface 124 can include an accelerator pedal and a brake pedal, and the driver input can include depression of the accelerator pedal and the brake pedal, respectively. The vehicle controller 116 can also control the drivetrain 108 and/or the transmission 112.

The vehicle 100 can also include a start-stop system 120. The start-stop system 120 can be configured to temporarily stop the engine 104 during periods of inactivity (or when operating on battery power in the example of a hybrid or electric vehicle) to decrease fuel consumption of the engine 104. The start-stop system 120 can stop the engine 104 based on at least one of the driver input and a speed of the vehicle 100. The speed of the vehicle can be determined based on a rotational speed of a component of the drivetrain 108 or the transmission 112, e.g., a transmission output shaft speed sensor. For example, the start-stop system 120 may stop the engine 104 when the brake pedal is depressed and the vehicle speed is approximately zero, such as when the vehicle 100 is at a stop light. The start-stop system 120 can then restart the engine 104 based on at least one of the driver input and the speed of the vehicle 100. For example, the start-stop system 120 can restart the engine 104 when the brake pedal is released or when the vehicle speed exceeds a threshold. Furthermore, in the example of an electric or hybrid vehicle, the state-of-charge of the battery and/or other operating conditions may also be factors when deciding to start or stop the engine 104. It should be appreciated that the above description of the operation of the vehicle 100 and associated vehicle start-stop system 120 provides a general overview of operation, which may omit details and simplify the actual operation of the vehicle.

The start-stop system 120 can be used to provide a desired voltage for one or more accessory components 128 (hereinafter “accessory components 128”) of the vehicle 100. The accessory components 128 can include low-voltage loads, e.g., 12V, such as headlights. It should be appreciated that the accessory components 128 can include any other suitable low-voltage loads of the vehicle 100 (a radio, a navigation system, etc.). The desired voltage can be a voltage for appropriate operation of the accessory components 128.

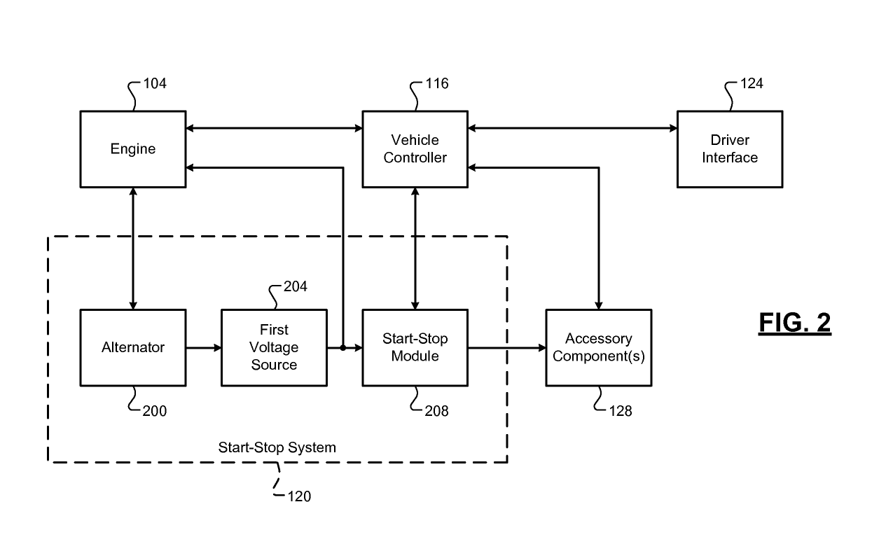

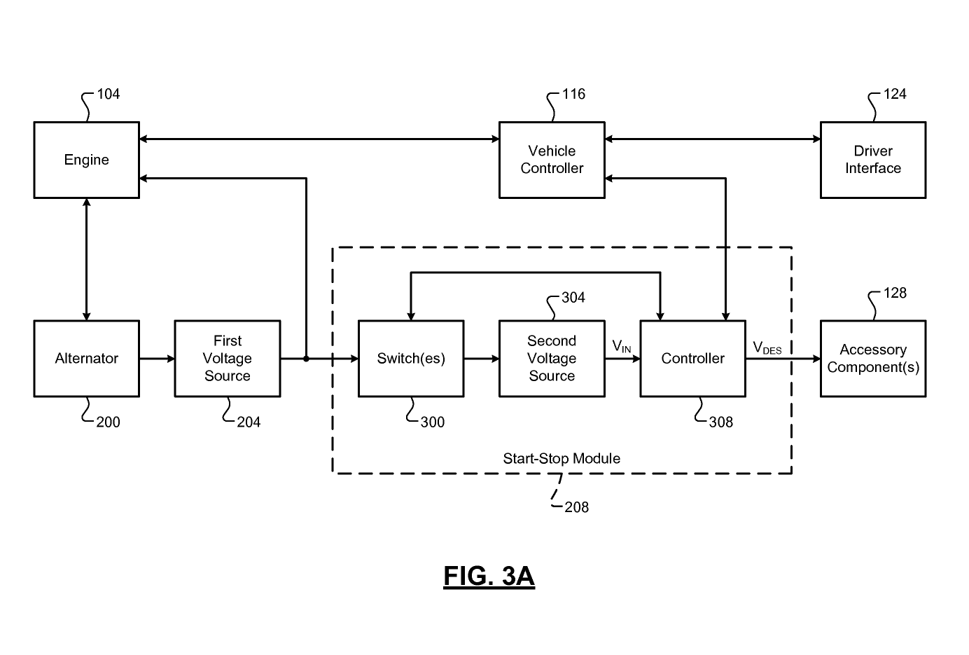

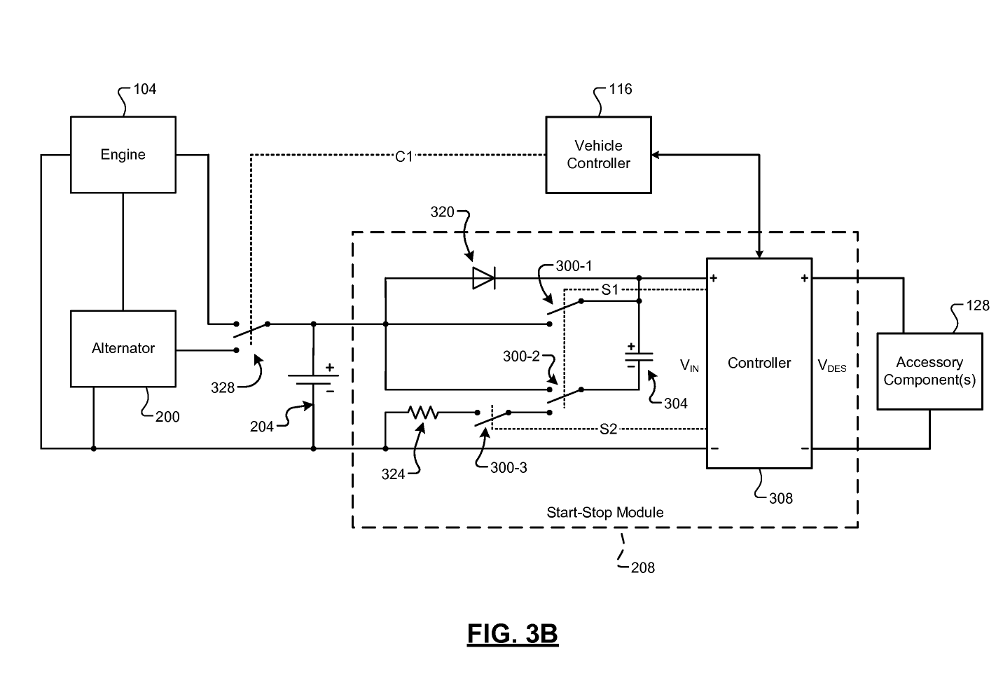

Referring now to FIG. 2, an example functional block diagram of the start-stop system 120 is illustrated. The start-stop system 120 can include an alternator 200, a first voltage source 204, and a start-stop module 208. It should be appreciated that the alternator 200 can be either part of the start-stop system 120 as shown or a separate component. The alternator 200 can convert mechanical energy generated by the engine 104 into electrical energy, e.g., current, to recharge the first voltage source 204. The alternator 200 can generate current when the engine 104 is running, but can be disconnected during cranking/starting of the engine 104 (see FIG. 3B). The first voltage source 204 can be a battery or another suitable electrical energy storage device. For example, the first voltage source 204 may be a lead-acid battery having a voltage in the range of 12V to 16V. The start-stop module 208 can include components for controlling the parallel/series connection between the start-stop module 208 and the first voltage source 204 (and, for the parallel connection, the alternator 200) and for stepping-down an input voltage to the desired voltage for the accessory components 128, which is described in more detail below.

Referring now to FIG. 3A, an example functional block diagram of the start-stop module 208 is illustrated. The start-stop module 208 can include one or more switches 300 (hereinafter “switches 300”), a second voltage source 304, and a controller 308. The switches 300 can be any suitable switches for switching between a parallel and series connection between the second voltage source 304 and the first voltage source 204 (and, for the parallel connection, the alternator 200), and vice-versa. For example, the switches 300 can each include one or more metal-oxide-semiconductor field-effect transistors (MOSFETs), insulated gate bipolar transistors (iGBTs), or electromagnetic contactors/relays.

The second voltage source 304 can be any suitable voltage source for providing additional voltage to power the accessory components 128 during restarting of the engine 104 by the first voltage source 204. For example, the second voltage source 304 can be a capacitor, such as a supercapacitor or an ultracapacitor. The second voltage source 304 could also be another suitable energy storage device, such as a battery. When the second voltage source 304 is a capacitor, its capacitance can be selected such that, after the engine is 104 restarted, an input voltage (V_{IN}) to the controller 308 is greater than a desired voltage (V_{DES}) for the accessory components 128. By implementing such a capacitor, the weight and/or cost of the start-stop module 208 can be decreased.

The controller 308 can control the switches 300 to switch between the standby mode (in which the second voltage source 304 is in parallel with the first voltage source 204) and the cranking mode (in which the second voltage source 304 is in series with the first voltage source 204). The controller 308 can also step-down the input voltage V_{IN} to the desired voltage V_{DES} when the second voltage source 304 is connected in series with the first voltage source 204. More particularly, the voltage V_{IN} can be much greater than the desired voltage V_{DES} when the second voltage source 304 is connected in series with the first voltage source 204, and thus the input voltage V_{IN} can be stepped-down to the desired voltage V_{DES} to maintain the performance of the accessory components 128. Further operation details of the controller 308 and a specific circuit configuration are described in detail below.

Referring now to FIG. 3B, an example circuit diagram of the start-stop module 208 is illustrated. As illustrated, the first voltage source 204 is a battery and the second voltage source 304 is a capacitor. The start-stop module 208 can include three switches 300-1, 300-2, and 300-3 (collectively referred to as “switches 300”). The start-stop module 208 can further include a diode 320 and a resistor 324. The diode 320 can provide uninterrupted current from the first voltage source 204 to the accessory components 128 during transition from standby to cranking mode, and prevent the second voltage source 304 from short-circuiting during the cranking mode. The resistor 324 can operate to limit the current to charge the second voltage source 304 during standby mode. The controller 308 can control the first and second switches 300-1 and 300-2, respectively, using control signal S1. Similarly, the controller 308 can control the third switch 300-3 using control signal S2.

Another switch 328 can connect the first voltage source 204 to either the engine 104 (e.g., a starter motor of the engine 104) or the alternator 200. More specifically, in cranking mode during cranking of the engine 104, the switch 328 is at a first (up) state to provide current to crank and start the engine 104. During normal operation of the engine 104 in standby mode, however, the switch 328 is at a second (down) state to allow the alternator 200 to convert mechanical energy from the engine 104 into electrical energy, e.g., current, to recharge one or both of the first voltage source 204 and the second voltage source 304.

By opening switch 300-1 and positioning switch 300-2 in a first (up) state, the controller 308 can connect the second voltage source 304 in series with the first voltage source 204. In contrast, by closing switch 300-1 and positioning switch 300-2 in a second (down) state, the controller 308 can connect the second voltage source 304 in parallel with the first voltage source 204. Because the first and second switches 300-1 and 300-2 are controlled by the same signal S1, these switches can also be referred to as a single switch. By operating (closing or opening) switch 300-3, the controller 308 can determine whether to recharge the second voltage source 304 (e.g., when its voltage is less than a predetermined level), or disconnect the second voltage source 304 from the system, e.g., when the second voltage source 304 has a state of charge above a level and the engine is temporarily stopped, or other situations dictate that the second voltage source 304 should not be charged (such as insufficient voltage on the first voltage source 204) The controller 308 can determine whether to recharge the second voltage source 304 based on one or more operation parameters of the vehicle 100. Examples of such operation parameters include, but are not limited to, the voltage of the first voltage source 204, the voltage of the second voltage source 304, a speed of the vehicle 100, and a temperature of a component/components of the vehicle 100.

During normal operation, the controller 308 can control the switches 300 to connect the second voltage source 304 in parallel with the first voltage source 204. During this period of inactivity, the second voltage source 304 is fully charged and the collective voltage V_{IN} of the first voltage source 204 and the second voltage source 304 is equal to a voltage of the first voltage source 204. This voltage is also equal to the desired voltage V_{DES} for the accessory components 128 and, therefore, the controller 308 can pass-through its input voltage V_{IN} as the desired voltage V_{DES} for the accessory components 128.

In some embodiments, when the vehicle controller 116 temporarily stops the engine 104 during start-stop operation and the voltage of the second voltage source 304 is greater than a predetermined level, the controller 308 can control the switches 300 to disconnect the second voltage source 304 from the system such that the second voltage source 304 does not discharge and maintains its voltage.

When the vehicle controller 116 determines to restart the engine 104, the controller 308 can switch to cranking mode and control the switches 300 to connect the second voltage source 304 in series with the first voltage source 204. The controller 308 can perform this task in response to another notification from the vehicle controller 116 that the engine 104 is about to be restarted. Once the series connection is established, the input voltage V_{IN} represents a sum of voltages of the first voltage source 204 and the second voltage source 304, which may be much greater than the desired voltage V_{DES}. The controller 308, therefore, can step-down the input voltage V_{IN} to the desired voltage V_{DES}. When the engine 104 begins cranking to restart, however, the voltage of the first voltage source 204 can drop substantially, e.g., from 12V-16V to 6V, and therefore the input voltage V_{IN} can decrease. The controller 308 can thus adjust its step-down procedure to continue outputting the desired output voltage V_{DES}.

Once the engine 104 has been restarted, the alternator 200 can begin generating electrical energy, e.g., current, which can recharge the first voltage source 204. During this recharging, the controller 308 can continue its procedure of stepping-down the input voltage V_{IN} to the desired voltage V_{DES}. Once the voltage of the first voltage source 204 reaches the desired voltage V_{DES}, the controller 308 can switch back to standby mode and control the switches 300 to connect the second voltage source 304 in parallel with the first voltage source 204 (and the alternator 200). Once the parallel connection is reestablished, the controller 308 can again pass-through the input voltage V_{IN} as the desired voltage V_{DES}. This process can then be repeated for subsequent start-stop operations.

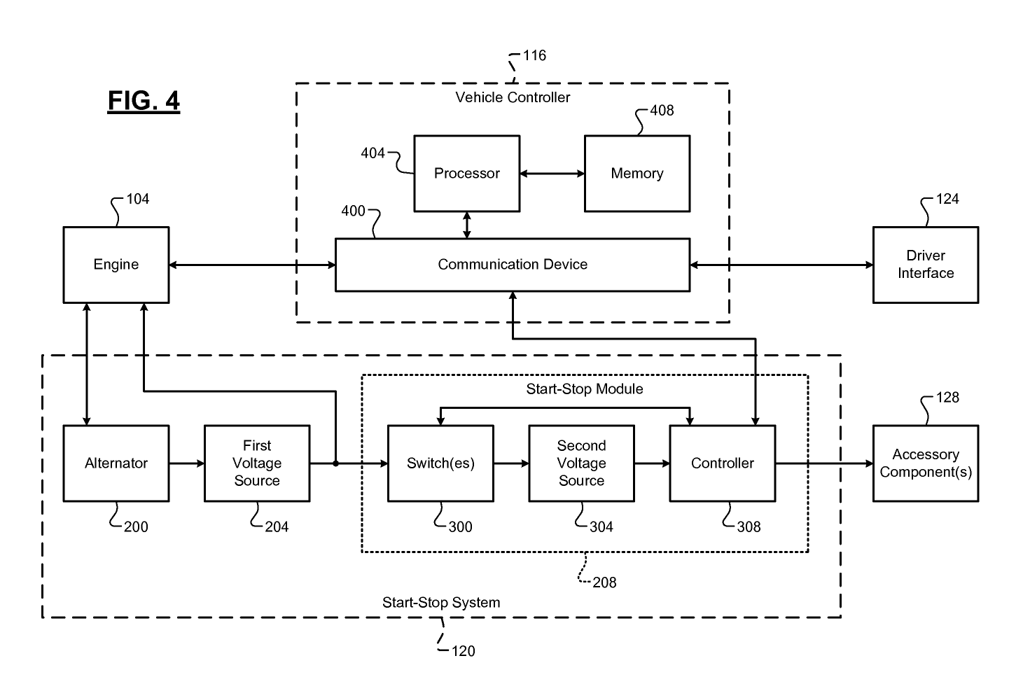

Referring now to FIG. 4, example functional block diagrams of the vehicle controller 116 and the start-stop system 120 are illustrated. The vehicle controller 116 can include a communication device 400, a processor 404, and a memory 408. The communication device 400 can include any suitable components for communication with other devices (the engine 104, the driver interface 124, switch 328, etc.) via a controller area network (CAN) or other suitable network. The processor 404 can control operation of the vehicle controller 116 and, thus, the vehicle 100. It should be appreciated that the term “processor” as used herein can refer to both a single processor and two or more processors operating in a parallel or distributed architecture. The memory 408 can be any suitable storage medium (flash, hard disk, etc.) configured to store information at the vehicle controller 116, such as parameters for vehicle start-stop operation and/or instructions to be executed by the processor 404.

Specifically, the processor 404 can control start-stop operation of the engine 104 via the communication device 400. More particularly, the processor 404 can interpret the driver input and/or vehicle speed from the driver interface 124 and the vehicle speed-related component (drivetrain 108, transmission 112, etc.), respectively, to determine whether to temporarily stop the engine 104 and whether to restart the engine 104. Similarly, the processor 404 can transmit signals to start/stop the engine 104 via the communication device 400. The processor 404 can also communicate the notifications to the controller 308 via the communication device 400. It should be appreciated, however, that the processor 404 can transmit signals to control the switches 300 and/or switch 328, and/or to control step-down operation of the controller 308. The controller 308, however, can have a same or similar structure as the vehicle controller 116 and, therefore, the controller 308 could perform all or some of these tasks itself.

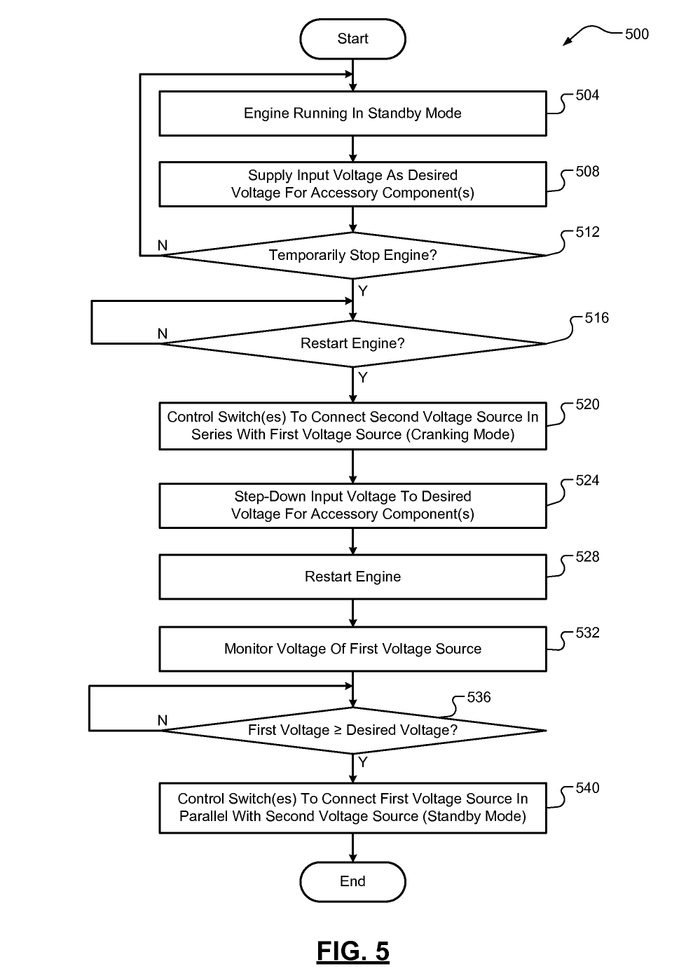

Referring now to FIG. 5, an example flow diagram of a method 500 for start-stop operation of the vehicle 100 is illustrated. At 504, the vehicle 100 is operating in standby mode with the engine 104 running. In standby mode, as described above, the controller 308 controls the switches 300 to connect the second voltage source 304 in parallel with the first voltage source 204. It should be appreciated, however, that the connection between these components may already be parallel, so this operation can be optional. At 508, the controller 308 can supply, e.g., pass-through, the input voltage V_{IN} as the desired voltage V_{DES} for the accessory components 128. At 512, the vehicle controller 116 determines whether to temporarily stop the engine 104 during start-stop operation. If true, the method 500 proceeds to 516. If false, the method 500 returns to 504. At 516, the vehicle controller 116 can determine whether to restart the engine 104. If true, the method 500 can proceed to 520. If false, the method 500 can return to 516.

At 520, the controller 308 can switch to cranking mode and control the switches 300 to connect the second voltage source 304 in series with the first voltage source 204. This can be in response to a notification from the vehicle controller 116 that the engine 104 is about to be restarted. At 524, the controller 308 can step-down the input voltage V_{IN} to the desired voltage V_{DES} for the accessory components 128. At 528, the vehicle controller 116 can restart the engine 104. At 532, the controller 308 can monitor the voltage of the first voltage source 204. The controller 308 can continue the active procedure of stepping down the input voltage V_{IN} to the desired voltage V_{DES} before, during, and after the starting of the engine 104. At 536, the controller 308 can determine whether the first voltage source 204 reaches the desired voltage V_{DES} or another suitable voltage threshold, that is, has a voltage (“first voltage”) equal to the desired voltage V_{DES} or another suitable voltage threshold. If true, the method 500 can proceed to 540. If false, the method 500 can return to 536. At 540, the controller 308 can switch back to standby mode and control the switches 300 to connect the second voltage source 304 in parallel with the first voltage source 204. The method 500 can then end or return to 504 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A start-stop module for a vehicle, comprising:
a first voltage source;
one or more switches configured to connect the first voltage source (i) in parallel with a second voltage source of the vehicle, or (ii) in series with the second voltage source; and
a controller configured to (i) receive an input voltage having a magnitude based on a connection between the first voltage source and the second voltage source, (ii) output a desired voltage that is appropriate for operating one or more accessory loads of the vehicle, and (iii) control the one or more switches to switch between a standby mode and a cranking mode,
wherein:
(i) the controller controls the one or more switches to connect the first voltage source in parallel with the second voltage source during standby mode,
(ii) the controller controls the one or more switches to connect the first voltage source in series with the second voltage source during cranking mode,
(iii) the controller switches to the cranking mode when the engine is not running and is about to be restarted during start-stop operation, and
(iv) the controller switches to the standby mode from the cranking mode after the engine has been restarted and when the second voltage source has a voltage that exceeds the desired voltage for the one or more accessory loads.

2. The start-stop module of claim 1, wherein the input voltage is equal to the voltage of the second voltage source plus a voltage of the first voltage source during cranking mode.

3. The start-stop module of claim 2, wherein the controller is further configured to step down the input voltage to the desired voltage during cranking mode.

4. The start-stop module of claim 1, wherein the desired voltage is equal to the input voltage during standby mode.

5. The start-stop module of claim 1, further comprising a diode connected in series between the second voltage source and the first voltage source such that (i) during transition from the standby mode to the cranking mode, the second voltage source provides uninterrupted current to the one or more accessory loads, and, (ii) during cranking mode, the first voltage source is not short circuited.

6. The start-stop module of claim 1, wherein the first voltage source is at least one of a capacitor, a supercapacitor and an ultracapacitor.

7. The start-stop module of claim 1, wherein standby mode is a default operating mode.

8. The start-stop module of claim 1, wherein an alternator of the vehicle is connected in parallel with the first and second voltage sources during standby mode to recharge at least one of the first and second voltage sources.

9. The start-stop module of claim 1, wherein the controller is further configured to determine whether to recharge the first voltage source based on one or more operation parameters, the one or more parameters including at least one of a voltage of the first voltage source, the voltage of the second voltage source, a speed of the vehicle, and a temperature of a component.

10. A start-stop system for a vehicle, comprising:
a first voltage source;
an alternator;
a second voltage source;
one or more switches configured to connect the second voltage source (i) in parallel with the first voltage source, or (ii) in series with the first voltage source; and
one or more controllers configured to:
temporarily stop an engine of the vehicle based on at least one of a driver input and a speed of the vehicle,
determine whether to restart the engine based on at least one of the driver input and the speed of the vehicle,
restart the engine in response to determining to restart the engine,
receive an input voltage having a magnitude based on a connection between the first and second voltage sources,
output a desired voltage that is appropriate for operating one or more accessory loads of the vehicle, and
control the one or more switches to switch between a standby mode and a cranking mode, wherein:
(i) the second voltage source is connected in parallel with the first voltage source during standby mode,
(ii) the second voltage source is connected in series with the first voltage source in during cranking mode,
(iii) the controller switches to the cranking mode when the engine is not running and is about to be restarted during start-stop operation, and
(iv) the controller switches to the standby mode from the cranking mode after the engine has been restarted and when the first voltage source has a voltage that reaches the desired voltage for the one or more accessory loads.

11. The start-stop system of claim 9, further comprising a diode connected in series between the first voltage source and the second voltage source such that (i) during transition from the standby mode to the cranking mode, the second voltage source provides un-interrupted current to the one or more accessory loads, and, (ii) during cranking mode, the first voltage source is not short circuited.

12. The start-stop system of claim 9, wherein the first voltage source is a battery and the second voltage source is a capacitor.

13. The start-stop system of claim 12, wherein the capacitor is a supercapacitor or an ultracapacitor.

14. The start-stop system of claim 9, wherein the one or more controllers are further configured to step down the input voltage to the desired voltage during cranking mode.

15. The start-stop system of claim 9, wherein the input voltage is approximately equal to the voltage of the first voltage source plus a voltage of the second voltage source during cranking mode.

16. A method of start-stop operation for a vehicle, comprising:
controlling one or more switches to connect a first voltage source in parallel with a second voltage source of the vehicle during a standby mode;
providing a desired voltage from a controller to one or more accessory components of the vehicle, the desired voltage being appropriate for operating the one or more accessory components of the vehicle;
stopping the engine of the vehicle;
determining whether to restart the engine of the vehicle;
switching to a cranking mode in response to determining to restart the engine;
controlling the one or more switches to connect the first voltage source in series with the second voltage source during the cranking mode such that the controller receives an input voltage approximately equal to a voltage of the first voltage source plus a voltage of the second voltage source;
stepping-down the input voltage to the desired voltage for the one or more accessory components of the vehicle during the cranking mode;
restarting the engine in response to determining to restart the engine;
monitoring the voltage of the second voltage source after restarting the engine; and
switching to the standby mode from the cranking mode when the voltage of the second voltage source reaches the desired voltage for the one or more accessory components of the vehicle.

17. The method of claim 16, wherein the first voltage source is a capacitor and the second voltage source is a battery.

18. The method of claim 17, wherein the capacitor is a supercapacitor or an ultracapacitor.

19. The method of claim 16, further comprising determining whether to recharge the first voltage source based on one or more operation parameters, the one or more parameters including at least one of a voltage of the first voltage source, the voltage of the second voltage source, a speed of the vehicle, and a temperature of a component

20. The method of claim 16, further comprising connecting an alternator of the vehicle in parallel with the first voltage source and second voltage source during standby mode to recharge at least one of the first voltage source and second voltage source.
